(19) United States
(12) Patent Application Publication
(10) Pub. No.: US 2024/0249242 A1
(43) Pub. Date: Jul. 25, 2024

(54) APPARATUS, SYSTEM, AND METHOD FOR PROCESSING CONTAINERS

(71) Applicant: Cornerstone Automation Systems, LLC, Frisco, TX (US)

(72) Inventors: Maxwell Amaro, Pea Ridge, AR (US); Richard Steele, JR., Plano, TX (US); Jonathan Webb, Allen, TX (US); Darian Carr, Richardson, TX (US); Brian McInnis, Bonham, TX (US); Angie Carter, Carrollton, TX (US); Don Moonis, Frisco, TX (US)

(21) Appl. No.: 18/420,568

(22) Filed: Jan. 23, 2024

Related U.S. Application Data
(60) Provisional application No. 63/481,090, filed on Jan. 23, 2023.

(51) Int. Cl. G06Q 10/087

(52) U.S. Cl. CPC G06Q 10/087

(57) ABSTRACT

Systems for processing products along a single flow path is provided. The systems can be in a linear arrangement that requires less space compared to other systems with multiple conveyors positioned at an angle, such as perpendicular, from a main conveyor. Processing of the products includes sorting containers including the products, such as from a shipment or delivery, and packing products into containers, such as for a delivery. In one example, a system includes: (1) a conveyor that transports containers, (2) at least one ID sensor that obtains sensed data as the conveyor transports the containers, (3) one or more visual displays for providing visual data, and (4) one or more processors to perform operations including determining container data based at least on the sensed data and displaying the container data on the one or more visual displays.

### CROSS-REFERENCE TO RELATED APPLICATION

This application claims the benefit of U.S. Provisional Application Ser. No. 63/481,090, filed by Maxwell Amaro, et al. on Jan. 23, 2023, entitled “AN APPARATUS, SYSTEM, AND METHOD FOR PROCESSING CONTAINERS,” commonly assigned with this application and incorporated herein by reference in its entirety.

### TECHNICAL FIELD

This application is directed to processing products and transfer systems, and more particularly, to processing containers and transferring products in a non-perpendicular direction.

### BACKGROUND

With the growth of e-commerce, many consumers purchase products on-line and have the purchased products delivered directly to them. Even so, consumers still frequent brick and mortar stores and purchase products that have been delivered to the stores from warehouses or distribution centers. Typically, the products are packed in containers, such as crates, pallets, boxes, totes, etc., and transported from the distribution centers or warehouses to the stores by trucks or other delivery vehicles. The products are then unloaded from the trucks and eventually placed in the stores for purchase.

### SUMMARY

In one aspect, the disclosure provides a system for processing containers. In one example, the system includes: (1) a conveyor that transports containers, (2) at least one ID sensor that obtains sensed data as the conveyor transports the containers, (3) one or more visual displays for providing visual data, and (4) one or more processors to perform operations including determining container data based at least on the sensed data and displaying the container data on the one or more visual displays.

In another aspect, the disclosure provides a method of processing containers from a delivery. In one example, the method includes: (1) receiving delivery data of the delivery, (2) receiving the containers of the delivery, (3) transporting the containers using a conveyor past at least one ID sensor, (4) sensing product data from the containers using the at least one ID sensor, and (5) visually presenting container data for the containers, wherein the container data is at least based on the product data.

In yet another aspect, a controller for a product processing system is disclosed. In one example, the controller includes one or more processors to perform operations including: (1) receiving product data from containers on a conveyor, (2) receiving customer data associated with the product processing system, and (3) visually presenting container data in one or more pick-up zones associated with the conveyor, wherein the container data is based on at least one of the product data or the customer data.

### BRIEF DESCRIPTION

The foregoing summary, preferred examples, and other aspects of the subject matter of the present disclosure will be best understood with reference to the detailed description of specific examples, which follows, when read in conjunction with the accompanying drawings, in which:

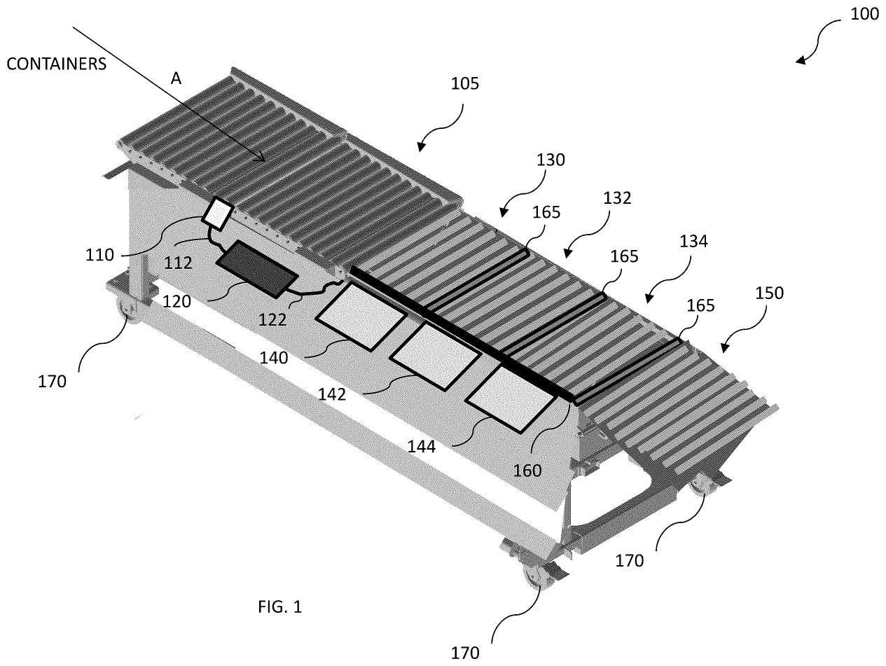

FIG. 1 illustrates a diagram of an example product processing system constructed according to the principles of the disclosure;

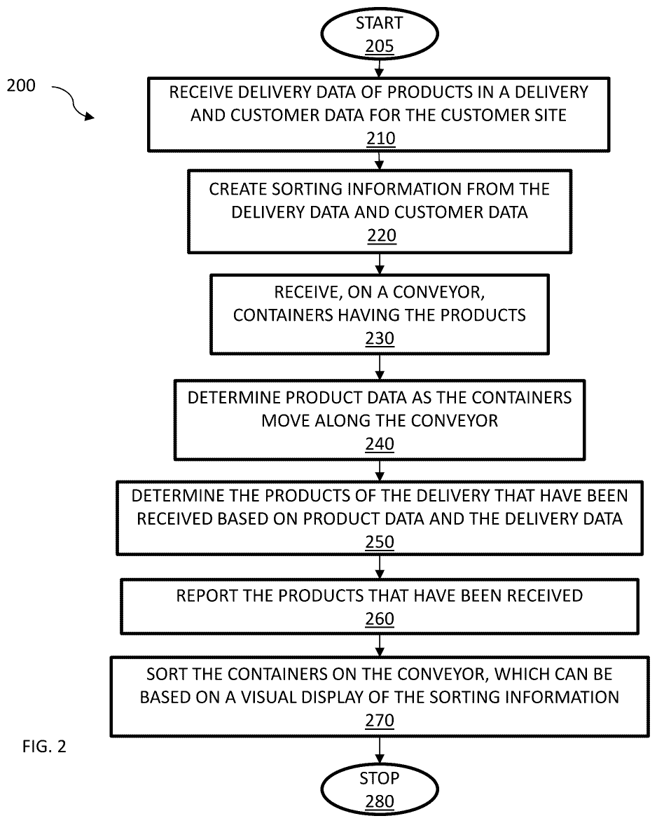

FIG. 2 illustrates a flow diagram of an example of a method for unloading products carried out according to the principles of the disclosure;

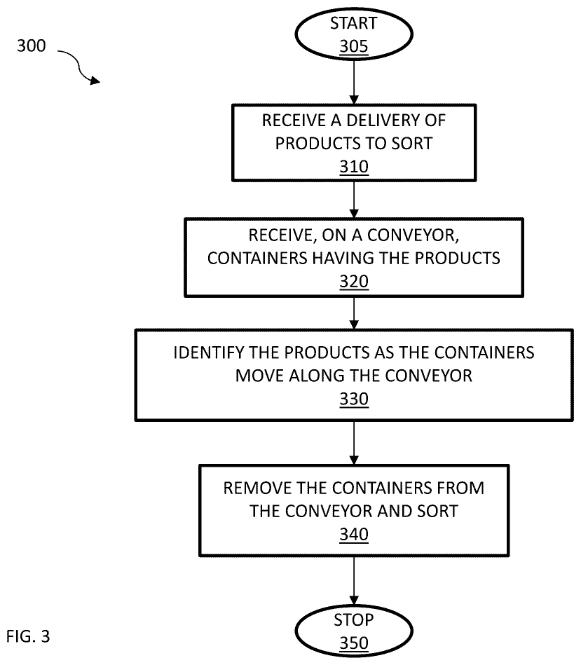

FIG. 3 illustrates a flow diagram of another example of a method for unloading products carried out according to the principles of the disclosure;

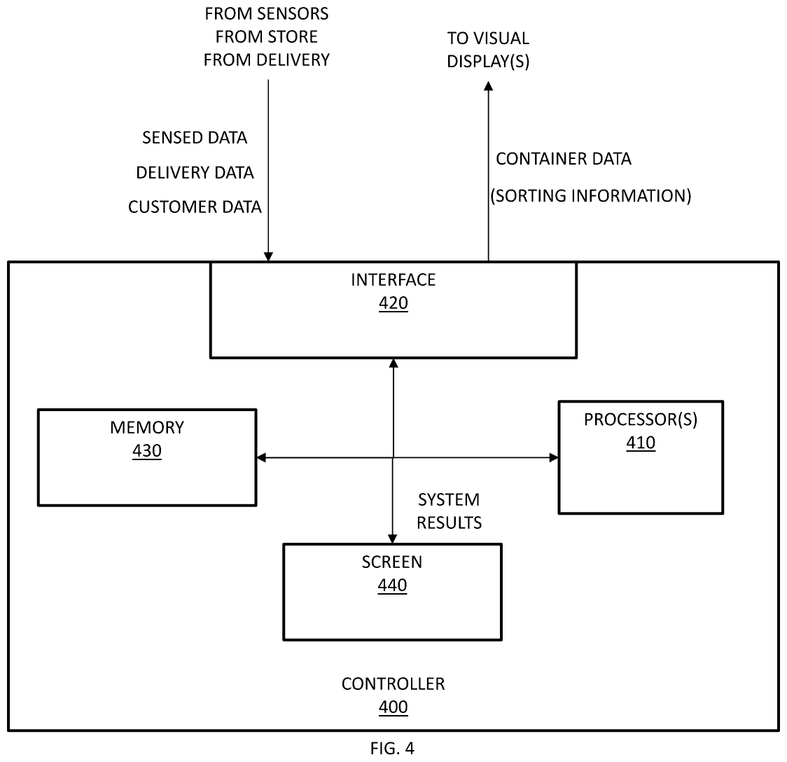

FIG. 4 illustrates a block diagram of an example of a controller to direct the processing of containers according to the principles of the disclosure;

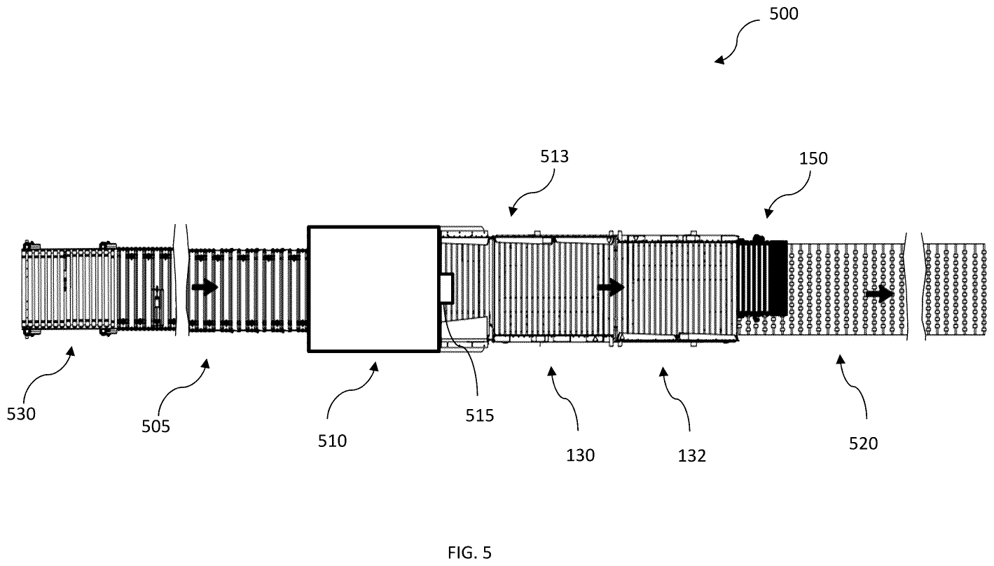

FIG. 5 illustrates a top view of an example of a product processing system for processing containers according to the principles of the disclosure;

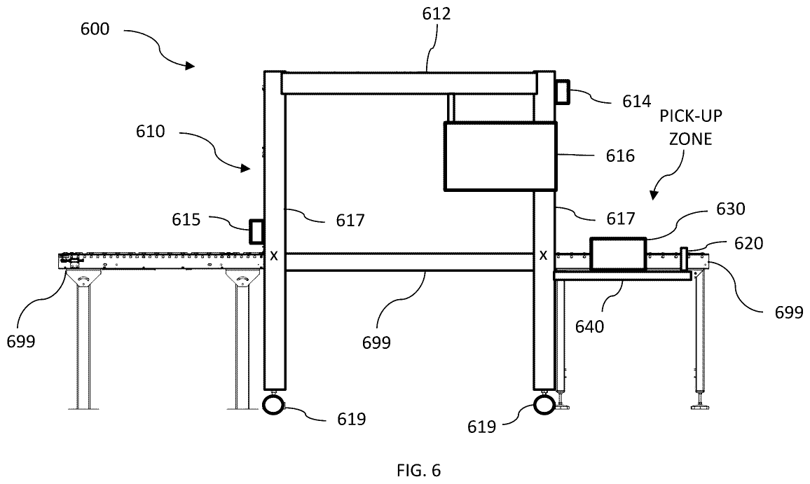

FIG. 6 illustrates an example of a mobile processing module constructed according to the principles of the disclosure; and

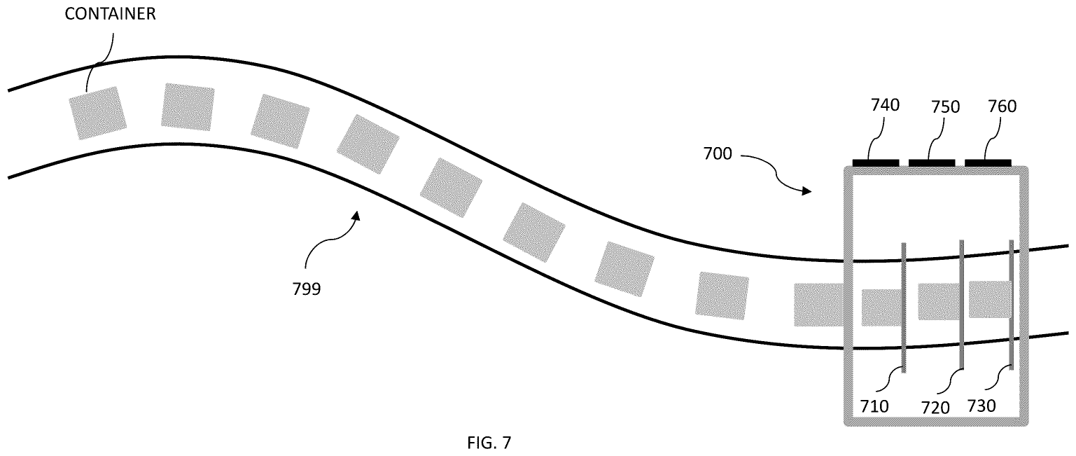

FIG. 7 illustrates an example of a mobile processing module being used with a conveyor and multiple stops that are used to define multiple pick-up zones on the conveyor according to the principles of the disclosure.

### DETAILED DESCRIPTION

Delivery vehicles, which includes trucks and semi-trailers, often include a mixture of different products that can be packaged in different types and sizes of containers. As such, the stores typically sort the containers when unloading such that the different products are delivered to the proper departments of the store. Various types of conveyors are often used to assist in unloading the delivery vehicles and sorting of the containers and products. For example, various conveyors can be arranged to sort the products to be distributed to the different departments. Unfortunately, the use of multiple conveyors requires space that may not be available in the store for unloading and sorting.

The disclosure provides product processing systems for processing products along a single flow path. The product processing systems can be in a linear arrangement that requires less space compared to other systems with multiple conveyors positioned at an angle, such as perpendicular, from a main conveyor used for unloading the products. Processing of the products includes sorting containers including the products, such as from a shipment or delivery (collectively referred to as a delivery), and packing products into containers, such as for a delivery.

The product processing systems can be stationary or mobile processing systems that can be used for sorting or packing of containers. Mobile product processing system can be used to establish a desired number of ‘aggregation zones’ for products and/or containers that can be used to minimize the average transit distance per container when processing containers, such as for sorting. Cooperating with a powered flexible conveyor can reduce or even eliminate indexing of products and/or containers when unloading deliveries. The mobility also allows the mobile product processing systems to be easily repositioned, similar to a flexible conveyor, if movement is necessary or desired. Accordingly, multiple layouts for receiving or packing products can be configured and may be daisy-chained. The multiple layouts can accommodate various sizes of receiving, packaging, or sorting areas and numbers of discrete sort groupings/zones, such as pick-up zones. The ease of configuration could be used to make use of incoming delivery composition analytics and optimizations. For example, delivery data could be processed before unloading and a complete unload dataset could be sent and stored locally on each of the mobile product processing systems for near instantaneous decision making for whether a container should be stopped at that particular processing system (or product zone(s) associated therewith).

The pre-processing of the incoming delivery data would also afford the advantageous ability to analyze what departments and quantities of containers for those departments are to be sorted such that the mobile product processing systems can be adjusted along the flexible conveyor (if necessary) for the optimally minimal transit distance for a specific delivery vehicle. Advantageously, if current processing locations are also tracked, the pre-processing of the delivery data can yield recommended high-impact location changes that should be made for even more optimally minimal unload time for an incoming delivery. Generally, if the population and quantity of products coming to a store is changing over time, the location information can be used for establishing better processing locations, such as for sorting. Accordingly, an area can be configured for sorting an incoming delivery by locating the mobile product processing systems according to the delivery data. For example, an instruction “move product processing system to marked position #7” could be sent by a processing controller to obtain a desired mobile product processing system setup with respect to a processing area for a processing event, such as sorting an incoming delivery.

The size and configuration of the product processing systems, including mobile systems, can vary. FIGS. 1 and 5 illustrates examples of product processing systems that can be stationary or mobile. FIGS. 6 and 7 illustrate other example configurations of mobile product processing systems referred to herein as mobile processing modules.

FIG. 1 illustrates a diagram of product processing system 100 constructed according to the principles of the disclosure. In this example, the system 100 includes at least one incoming conveyor 105, one or more ID sensors represented by sensor 110, a controller 120, multiple pick-up zones represented by pick-up zones 130, 132, 134, a visual display 140, 142, 144, for each of the pick-up zones, and a jackpot 150. In other examples, instead of multiple pick-up zones there could be a single pick-up zone. The system 100 also includes wheels 170 that allow the system to be moved for processing events, such as unloading delivery vehicles. In addition to or instead of wheels, the system 100 could be on skids or another type of movement system or device to promote repositioning or movement of the system 100. Accordingly, the system 100 can be moved to designated locations for particular events, such as loading or unloading. The system 100 may not include wheels and can be essentially stationary or immobile once positioned.

The system 100 moves containers along a single flow path, represented by flow path A in FIG. 1. The movement can be automatic or manual. As such, conveyor 105 can be a powered motor driven conveyor. The system 100 can be, for example, a sorting system used to sort containers having products that are part of a delivery to a customer site, such as a store or warehouse. The system 100 can also be used as a packing system for placing products in containers for distribution or delivery.

The conveyor 105 receives containers. The containers can be empty or include items, such as a product or packing material for shipping a product. As such, the containers can be closed and sealed with a product inside, open with no product inside, or even open with product inside. When open with a product inside, the containers can be closed later for shipping after one or more of, for example, inspection of products, receipt of packing material, inclusion of tracking device, etc. An open container with a product inside can also be a delivered container that was opened after delivery. For example, the delivered containers can be opened manually or automatically via an automated system that removes the tops of containers, such as cardboard boxes. One or more additional conveyors can be attached to either end or both ends of the system 100, as shown in FIG. 5 with conveyors 530, 505, and 520. For example, the containers can be part of a delivery and a conveyor or conveyors can be extended into or proximate a delivery vehicle and feed conveyor 105 for unloading and sorting the containers. In some examples, the containers may be placed directly onto the conveyor 105 from a delivery vehicle. Multiple conveyors can be aligned instead of using a single conveyor 105. A first conveyor, such as a flexible conveyor, can feed a second conveyor associated with the ID sensor 110, which feeds another conveyor that includes pick-up zones 130, 132, 134, that feeds yet another downstream conveyor. As such, pick-up zones 130, 132, and 134 may be on a different conveyor that is physically separated from conveyor 105

The conveyor 105 moves the containers past the ID sensor 110, which obtains data associated with the containers. The sensed data can include product data that corresponds to products that are already within the containers, such as with delivered containers. The product data can include the identity of a product and can also include additional information about the product, such as the physical condition or state of the product. For example, a container can include ice cream and the product data can identify the product as ice cream, the type of ice cream, the brand of ice cream, etc., and can also include the temperature of the ice cream. In addition to the present temperature of the ice cream, a history of the temperatures during delivery and storage can be tracked and provided as part of the product data. As such, the containers can include sensors that deliver information about the product including information obtained during shipment of the product. This information can then be used for sorting. For example, one or more sensors can be placed in a container containing a fragile product. The one or more sensors can indicate the container has been dropped or suffered impact to an extent that surpassed a threshold corresponding to likely damage to the fragile product. As such, the product data could be used to identify a potentially damaged product that should be sorted to a dedicated location. With the ice cream example, the temperature data could be used to provide expedited sorting and delivery to a freezer section of a customer site. The product data can also correspond to products that are to be placed in the containers, such as for shipping or storage. The sensed data can also include information about the container itself, such as physical dimensions, a delivery destination, a delivery origin, an originating company, a destination company, etc. The sensed data can be used to obtain sorting instruction. For example, sensed product data can be used to obtain sorting instructions from a look-up table. The look-up table can be stored on a computing device associated with a customer site and/or can be stored on a memory or data storage of the controller 120.

The ID sensor 110 can be one of various types of sensors, such as cameras or scanners. The scanners can be RF scanners, bar code scanners, or other types of scanners that correspond to identifiers on the containers or the products within the containers when present from which the sensed data, such as product data, can be obtained. The identifiers can be placed on or integrated with the container during manufacturing, during delivery, during packing, etc. A combination of different sensors can be used and can be located in different positions with respect to the conveyor 105. As noted above, ID sensor 110 represents the one or more sensors that can be used. One or more sensors can be located in a canopy or halo that extends over the conveyor 105 or other conveyors connected to conveyor 105. FIG. 5 provides an example of a product processing system that includes a halo 510 wherein the sensor 110 is mounted.

The ID sensor 110 delivers the sensed data to the controller 120 via a connection 112. The connection 112 can be hardwired as illustrated or wireless. In addition to the sensed data, the controller 120 can also receive delivery data that identifies the products of a delivery and customer data that associates the products of the delivered containers with particular departments of the store and/or sorting instructions for various products if applicable. For example, the sorting instructions can include a location for any product that is identified as potentially damaged, include a specific person to pick-up a particular container or containers, expedited instructions for sorting time/temperature sensitive products (such as ice cream), etc. The delivery data and the customer data can be received via a wireless connection, a wired connection, or a combination of both.

The controller 120 includes one or more processors that perform operations to direct the system 100. The operations can vary depending on, for example, the customer site, a user's preference, how the system 100 is being used (such as for sorting, delivering, or packing) or a combination thereof. The operations include, for example, determining the containers and/or products of the delivery that have been received at the customer site based on the sensed data obtained by the ID sensor 110. The one or more processors (simply referred to as processor), for example, can compare the product data to the delivery data to verify products that were received and identify products that were supposed to be delivered but were not delivered. Additionally, products can be identified that were received but were not expected to be delivered. Similarly, the sensed data can be compared to the delivery data to determine the containers that were supposed to be delivered and/or containers that were received but were not expected to be delivered. Controller 400 in FIG. 4 provides an example of controller 120.

The operations can also include generating or gathering container data for containers using the sensed data (such as the product data), the delivery data, and the customer data. The container data can identify the product within the containers, the associated department for the product to be sent, sorting information from the sorting instructions of the customer data and product data of the sensed data, and/or a combination thereof. The sorting information can indicate, for example, if a product or products should be unloaded to a certain pallet and the location of the pallet, or another sorting location.

The operations can also include generating system results reporting the status of the system 100. The controller 120 can send the system results to a screen (not shown in FIG. 1 but an example screen is shown in FIG. 4 and FIG. 6 for display. The system results can, for example, indicate the status of a delivery and the sorting of the delivery. The system results can include products of the delivery from the delivery data, sorting instructions for the products, such as from the customer data, condition of the products, and the sorting status. The sorting status indicates if a container has been picked-up from the conveyor 105. The sorting status can use data from one or more container sensors, represented by container sensor 160, located with the conveyor 105. The container sensor 160 can be photoelectric sensors that use light beams to determine the presence of a container in a corresponding area of the conveyor 105. The container sensor 160 can be a proximity sensor that uses electromagnetic or capacitive fields to detect the presence of the container. The controller 120, which knows the order of the containers traveling along the conveyor 105 based on the product data received from the ID sensor 110, can combine that tracking information with information received from the container sensor 160, which indicates the presence of a container and when the container has been removed from the conveyor 105, to generate the sorting status. One or more controllers, such as controller 120, can be used for the tracking process.

Using controller 120 as an example, controller 120 can include a single computing device or include multiple computing devices that cooperate to perform certain functionalities. As such, the controller 120 can have distributed functionality across multiple computing devices. For example, the controller 120 can include an industrial PC and a programmable logic controller (PLC) that work in coordination with received data, such as customer data, and ID sensor 110. The PLC can send signals to drive cards located in each of the pick-up zones 130, 132, 134. One or more of the pick-up zones 130, 132, 134, can also include a PLC that communicates with the controller 120 and the drive cards. The PLCs, regardless of location, can be programmed and the logic of each of the drive cards can be programmed. The PLCs or drive cards can be programmed to monitor information from the container sensor 160 to determine if a product is picked up or arrives at a pick-up zone earlier than expected. This information can be used to detect sorting status of expected containers and the presence of unknown containers. For example, if a container is detected in pick-up zone 134 by container sensor 160 in an amount of time that is less than an expected amount of time for moving, for example, from zone 132 to 134, then the container detected is likely an unknown container that has been placed in the system 100. The PLCs and drive cards can cooperate with the container sensor 160 to determining jamming. For example, if a container is in pick-up zone 130 or 132 and zone 134 opens up, the motors would be activated in the appropriate zones to move the container into pick-up zone 134. If the container sensor 160 does not indicate a clear (no container) in pick-up zone 130 or 132, then a jam is probable and manual intervention may be needed. The controller 120 can send out an alert if manual intervention is needed. The alert can be audible, visible, or both. The alert can contact a specific person or group, such as via a text message. Also, one or more of the containers can extend into more than one of the pick-up zones 130, 132, 134. The container sensor 160 can indicate the presence of a container in more than one pick-up zone.

Container sensor 160 may include a corresponding piece on the opposite side of the pick-up zones to indicate the presence of an item, such as a transmitter and receiver. FIG. 1 also illustrates another example of container sensors 165 that can be used. Here each of the pick-up zones include a container sensor 165 that indicates the presence of a container. The container sensors 165 can be located on stops that are activated by the controller 120. Further discussion of stops is provided with FIGS. 6 and 7. This information gathered by the container sensors 165 can be used for tracking containers in the same way as discussed about for container sensor 160. The container sensors 165 can be photoeyes. Regardless the type, the system 100 can use container sensors to locate the presence of containers. This information can be provided as one or more inputs to the controller 120, which can then use the information for tracking containers in the system 100.

As indicated above, the system 100 can be a mobile system that is positioned for different events using the wheels 170. A portion of the system 100 may also be mobile. For example, the sensor 110 and controller 120 can be mobile and positioned with respect to a separate conveyor for processing containers. A nimble and mobile integrated module that includes the sensor 110 and possibly the controller 120 can be designed for maneuverability (e.g., lightweight, wheels, narrow width but sufficient width to fit with and operate with industry conveyors). Such a mobile system may include the sensor 110 and a communication interface for communicating (e.g., wireless, wired, or combination) with the controller 120. As such, multiple mobile product processing systems can be used that include a sensor 110 and communicate with a single controller. The single controller, for example, can be located in an unloading area, warehouse, etc., the single controller can also be mobile or in a more fixed location. In some examples, a mobile product processing system may include sensor 110 and one or more pick-up zones and be used with a separate conveyor. In this example, the controller 120 can also be included or located separately and communicatively coupled to the sensor 110 and the one or more pick-up zones. The mobile product processing system can be in different forms that integrate with a separate (e.g., not a single unit) conveyor. The example mobile product processing system could also include one or more pick-up zones, such as pick-up zone 130, and one or more visual display, such as visual display 140. In some examples, a mobile product processing system can be moved and positioned by a single operator. FIGS. 6 and 7 provide additional information and examples of a configuration of a mobile product processing system referred to as a mobile processing module.

Continuing the example of using the system 100 to sort a delivery, the containers are moved along the conveyor 105, past the sensor 110 to a pick-up area that includes the pick-up zones 130, 132, 134. The pick-up area is where users can remove containers from the conveyor 105. The jackpot 150 is located past the pick-up zones 130, 132, 134, and is a transition mechanism for products that are leaving the conveyor 105 and proceeding to another sort location. A skate wheel conveyor, a powered motor driven roller conveyor, or another conveyor can be associated with the jackpot 150 for transporting containers in the jackpot 150 to the other sorting location, such as an area for potentially damaged products. The various types of conveyors can, for example, either be mechanically connected, wheeled up next to the jackpot 150, or located underneath the jackpot 150. The containers can be manually or automatically moved across the additional conveyor to the other location. Similarly, the containers can be manually or automatically moved across the conveyor 105.

For automated movement, rollers of the conveyor 105 can be operated to move the containers. The automated movement can be continuous or non-continuous. PLCs of the controller 120, such as located with the pick-up zones, and the drive cards can cooperate for automated movement as mentioned above by controlling motors in each of the pick-up zones 130, 132, 134. For example, if a container is intended to stop in a pick-up zone of the system 100 at some point, the container is scanned and then moves to the furthest position of the pick-up zones 130, 132, 134, that is either not occupied by another container (accumulation) or is not the jackpot 150. A first container A would move from position 130 to 132 to 134 with only a momentary stop at each one (for example 0.1 seconds) of the pick-up zones. When container A was in pick-up zone 130 then visual display 140 would display the container data of container A. When container A moves from pick-up zone 130 to zone 132, visual display 140 stops displaying the corresponding container data of container A and visual display 142 displays the container data of container A. When container A moves from pick-up zone 132 to zone 134, visual display 142 stops displaying the corresponding container data of container A and visual display 144 starts displaying the container data of container A. Visual display 144 continues to display the container data of container A until container A is picked-up. If container A is not picked up from pick-up zone 134 and another container, container B is introduced to system 100, container B will move from pick-up zone 130, to pick-up zone 132 and stop. Even if container B is intended to go to jackpot 150 it will remain at pick-up zone 132 with the container data of container B displayed on it (likely “Jackpot” or something else indicating to not pick up container B). A PLC, such as a PLCs associated with each of the pick-up zones, can cooperate with the controller 120 and can direct the corresponding visual displays to display the appropriated container data.

In another example, the conveyor 105 can move the containers to the pick-up zones 130, 132, 134, where the containers remain according to a designated amount of time within each of the pick-up zones 130, 132, 134. As such a container can be automatically moved to pick-up zone 130 and if not retrieved in, for example, 5 seconds, then moved to pick-up zone 132. If not retrieved from pick-up zone 132 within 5 seconds, the container can then be moved to pick-up zone 134 for 5 seconds or until retrieved. If not retrieved, the conveyor 105 can then move the container to the jackpot 150. The designated amount of time can be changed for the pick-up zones 130, 132, 134, and can be different for one or more of the pick-up zones 130, 132, 134.

As mentioned above, one or more of the pick-up zones 130, 132, 134, can include a PLC and/or drive cards that control the rollers to move the containers. The controller 120 can cooperate with the PLC and/or drive cards to set the designated amount of time when non-continuous movement is desired. The controller 120 can communicate with the PLC via connection 122, which can be hardwired as illustrated or wireless. The controller 120 can send control commands to the PLC for operating the conveyor 105.

With the control commands, the controller 120 can also send the container data to visual displays 140, 142, and 144, such that each of the visual displays can visually present the container data for the container that is located in each of the corresponding pick-up zones 130, 132, 134. The controller 120 can cooperate with PLCs in each of the pick-up zones to provide the container data. As noted above, a container can be located in more than one of the pick-up zones. The container data can be an arrow that points to the jackpot 150. The visual displays 140, 142, 144, can be screens. Though an individual visual display is illustrated for each of the zones, a single visual display can be used for more than one of the pick-up zones 130, 132, 134. For example, a single visual display could be used for the pick-up area. The visual display could be a rolling display that displays the container data. Instead of text or in addition to text, the visual displays could also be a series of colored lights that correspond to particular departments of the store. In some applications, the system 100 may not include a visual display. Instead of a visual display, a speaker or other user interface could be used to communicate to an operator.

In the above discussion of the system 100, the example of sorting a delivery of products was used. As noted, the system 100 can also be used for other functions, such as for packing products in containers. In such applications, empty containers can pass by sensor 110 and a visual display or screen, such as in FIG. 1, 4, or 6, can show container data that indicates what needs to be placed in the container. The ID sensor 110 can sense data that is used to obtain container data from a look-up table stored, for example, on the controller 120. The system 100, as such, can be used for multiple operations. For example, the system 100 can be used for packing containers that are, for example, loaded for a delivery and can also be used for sorting a delivery. FIGS. 2 and 3 illustrate flow diagrams of examples of methods for unloading products from a delivery vehicle carried out according to the principles of the disclosure.

FIG. 2 illustrates a flow diagram of an example of a method 200 for unloading products carried out according to the principles of the disclosure. The products can be on a delivery vehicle as part of a delivery to a customer site, such as a store or warehouse, and can be in containers. A product processing system may be used for unloading the products. Accordingly, the product processing systems in FIGS. 1, 5, 6, and 7, or a combination thereof, can be used for performing method 200. Method 200 starts in step 205.

In step 210, delivery data of the products in the delivery and customer data for the customer site are received. The delivery and customer data can be received by a controller, such as controller 120, via a wireless or wired connection. The delivery data identifies the products of the delivery and the customer data associates the products with particular departments of the customer site and/or sorting instructions for various ones of the products if applicable.

Sorting information is created from the delivery data and customer data in step 220. The sorting information includes the applicable sorting instructions and site data from the customer data for the products identified from the delivery data. One or more processors, such as a processor of controller 120, can receive or generate the sorting information.

Containers having the products are received in step 230. The containers can be received via one or more conveyors extending from the delivery vehicle. A conveyor can be extended into the delivery vehicle or located proximate the delivery vehicle for unloading.

In step 240, product data is determined as the containers move along the conveyor. One or more sensors, such as ID sensor 101, can obtain the product data as the containers pass by the sensor. The product data can include the identity of a product and can also include additional information about the product, such as the physical condition or state of the product.

The products of the delivery that have been received are determined in step 250. The received products can be determined based on product data that was sensed and the products denoted in the delivery data. A processor or processors, such as from controller 120, can compare the product data to the identified products of the delivery data to determine the identified products that have been received.

In step 260, the products that have been received are reported. The received products determined in step 250 can be reported by a controller, such as controller 120. The received products can be delivered, for example, to an inventory system of the customer site and/or sent to a designated person. A communications interface of a controller, such as interface 420 in FIG. 4, can be used to report the received products.

The containers on the conveyor are sorted in step 270. The sorting of the containers can be based on a visual display of the sorting information. The sorting information can be provided on visual displays associated with pick-up zones, such as the visual displays 140, 142, 144, of FIG. 1. The sorting information can be part of container data that is generated by the processor of the controller from the product data that is sensed, and the delivery data and customer data that is received. The sorting can include removing containers from the pick-up zones and placing the containers in a desired location according to the sorting information. Method 200 continues to step 280 and ends. Method 200 can end when sorting of the containers of the delivery is complete.

FIG. 3 illustrates a flow diagram of another example of a method 300 for unloading products carried out according to the principles of the disclosure. As with method 200, the products are in containers and can be in a delivery vehicle as part of a delivery to a customer site. A product processing system, such as in FIG. 1, 5, 6, or 7, or a combination thereof, may be used for unloading the products. Method 300 starts in step 205.

In step 310, a delivery of products to sort is received. The delivery can be from a delivery vehicle and a delivery dock can be used. The delivery can be a scheduled delivery that was expected or can be an unscheduled delivery without delivery data.

Containers having the products are received via a conveyor in step 320. The containers can be received via one or more conveyors extending from the delivery vehicle. A conveyor can be extended into the delivery vehicle or located proximate the delivery vehicle for unloading.

In step 330, the products are identified as the containers move along the conveyor. One or more sensors, such as ID sensor 110, can identify the products in the containers as the containers pass by the ID sensor.

The containers are removed from the conveyor and sorted in step 340. The removal of the containers from the conveyor and the sorting of the containers can be based on a visual display that provides container data. The container data, which can include sorting information, can be provided on visual displays associated with pick-up zones, such as the visual displays 140, 142, 144, of FIG. 1. The container data can be generated based on the sensed data from the ID sensor. The sensed data can also be used to obtain the sorting instructions, such as from a look-up table, and the container data can include the obtained sorting instructions. Based on the container data, a user can remove or leave a container on the conveyor, such as from one of the pick-up zones. Removed containers can be placed in the proper departments of the receiving store, placed on a pallet, moved to another location, etc. according to the sorting information. Method 300 continues to step 350 and ends. Method 300 can end when sorting of the delivery is complete.

FIG. 4 illustrates a block diagram of an example of a controller 400 such as used in or with one of the product processing systems of FIG. 1, 5, 6, or 7. The controller 400 includes one or more processors represented by processor 410, one or more communications interfaces represented by interface 420, one or more memories represented by memory 430, and a screen 440. The functionalities performed by the processor 410 can be distributed across different computing devices, such as discussed above regarding the controller 120. Each of the components of controller 400 can be connected via wireless or wired communication connections typically used in the industry. One skilled in the art will understand that the controller 400 can include additional components typically included with a controller such as a power supply or power port.

The interface 420 includes multiple ports for transmitting data to and receiving data from a product processing system, such as represented in FIGS. 1, 5, 6, and 7. The interface 420 can support wireless or wired communications. Additionally, the interface 420 can receive programming to direct the operation of the processor 410. The operating instructions can be code representing algorithms that, for example, process containers and products with a conveyor. The processor 410 can generate operating commands that direct the operation of a product processing system to process containers such as disclosed herein; for example according to methods 200 or 300. The commands can direct operation of the conveyor to move containers for sorting or packing.

The processor 410 can perform operations for processing containers with a conveyor as disclosed herein. The processor 410 can be directed by a series of operating instructions that correspond to one or more algorithms for processing the containers. The series of operating instructions can be received via the interface 420 and stored on the memory 430.

The interface 420 can also receive the sensed data, the delivery data, and the customer data. The processor 410 uses one or more of the received data to generate container data that is provided to one or more visual displays, such as visual display 140. The container data can include sorting information that directs a user to remove or leave containers with the conveyor, such as in pick-up zone 130. The processor 410 can also generate system results and provide to the screen 440 for display.

The memory 430 is constructed to store data and computer programs. The memory 730 can be a conventional memory used in the industry. The memory 730 may be a non-transitory computer readable medium store operating instructions to direct the operation of the processor 410 when initiated thereby. The operating instructions may correspond to algorithms that provide the functionality of the operating schemes disclosed herein. The memory 430, therefore, stores the operating instructions that direct the operation of a product processing system, such as disclosed herein. The memory 430 can also store data look-up tables that can be accessed using, for example, sensed data from a container. The processor 410 can use the look-up data to determine, for example, sorting instructions.

The screen 440 is used to provide a visual display of information, such as system results. The screen 440 can be a conventional screen that is used with computing devices. One or more of the processor 410, interface 420, memory 430, and screen 440 can be integrated into a single computing device.

FIG. 5 illustrates a top view of a product processing system 500 for processing containers according to the principles of the disclosure. The product processing system 500 includes a halo 510 attached to conveyor 513 wherein a sensor 515 is mounted on the top portion of the halo 510 and obtains the sensed data as containers pass through (or under) the halo 510 connected to conveyor 513. The halo 510 can be connected via a mechanical connection to the conveyor 513. Conveyor 513 and sensor 515 can operate as conveyor 105 and sensor 110 of FIG. 1. One skilled in the art will understand that some features visible in FIG. 1 are not visible in the top view of FIG. 5. For example, a controller of the mobile processing module 500, similar to the controller 120 of FIG. 1, is integrated with the halo 510 and is not visible in FIG. 5. FIG. 5 also includes an additional conveyance represented by a skate wheel 520 that is located after the jackpot 150. A powered flexible conveyor 530 is also shown in FIG. 5 connected to a conveyor 505, which can also be a powered flexible conveyor. Conveyor 505 feeds conveyor 513 of the product processing system 500. The product processing system 500 is an example of a processing system that can be stationary or mobile.

FIG. 6 illustrates a side view of an example of a mobile processing module 600 constructed according to the principles of the disclosure. The mobile processing module 600 includes a mobile frame 610 having a halo 612, which has an ID sensor 614 and a controller 616 attached thereto. The mobile frame 610 also includes legs 617 that extend to the floor and rest on wheels 619 for ease of movement. The halo 610 is designed to straddle a separate conveyor 699 and have a minimal profile width to accommodate tight spaces and maneuverability. In some examples the legs 619 may not extend to the floor but instead attach to the conveyor 699 for support. The “x” on each of the legs 619 at the conveyor 699 represent an attachment point. Regardless if attached to a conveyor or supported by legs extending to the floor, the mobile processing module 600 can be moved along a single conveyor or to different conveyors for different container events, such as a delivery, and then moved for another container event if necessary.

As noted above, the mobile processing module 600 is positioned wherein the halo 612 is over conveyor 699. Essentially the conveyor 699 passes through the mobile processing module 600. With the mobile processing module, the ID sensor 614 may be positioned proximate or concurrent with a first pick-up zone, which could reduce the overall length of the module. The ID sensor may also be positioned further upstream, such as represented by the alternate location of ID sensor 615, a distance from the pick-up zone to allow sufficient time for scanning and processing the obtained sensor data. In some implementations, more than one ID sensor can be used, such as to provide a check of the sensing. Conveyor speed and/or computer processing speed can affect the distance needed. The mobile processing module 600 does not have an integrated conveyance, but instead works with one or more separate conveyors, such as a conveyor 699. Conveyor 699 can be of an arbitrary length to accommodate any length of receiving, packing, or processing area. The mobile processing module 600 could be easily moved up and down the conveyor 699 to various desired positions with minimal personnel required, such as a single operator.

The mobile processing modules can be powered from one of a plethora of receptacles built into a powered flexible conveyor. For example, a receptacle built into a leg set of a powered flexible conveyor can be used to provide power. A mobile processing module can also include wireless data transmission capability to minimize physical connections when the mobile processing modules are positioned. A single controller could be used for all or at least multiple of the mobile processing modules.

The mobile processing module 600 includes a stop 620 and a visual display 630. A support arm 640 is shown as an example of connecting the stop 620 and the visual display 630 to the mobile frame 610 and positioning the stop 620 and the visual display 630 with respect to the conveyor 699 to create the pick-up zone. The stop 620 can be low profile stop that would be clear of the conveyor 699 when positioning the mobile processing module 600 with respect to the conveyor 699, but could rest below between the rollers of the conveyor 699, such as scissor-rollers of a powered flexible conveyor, when the mobile processing module 600 is in a desired position with the flexible conveyor 699 and activated. In one implementation, a container sensor (such as container sensor 165) may be integrated into the top of stop 620 to detect movement of a container into the pick-up zone. The container sensor can communicate with the controller 616 for determining if stop 620 should be raised or not raised. For example, a stop for a subsequent or downstream pick-up zone when present may be raised if a container is for that that pick-up zone. Accordingly, the mobile processing module 600 can be used to identify containers and stop the container at a desired location along conveyor 699, wherein stop 620 can be used to halt containers where desired.

The visual display 630 provides container data, which can inform a user what to do with the stopped container. In addition to being used with mobile processing module 600, stops can also be used with the system 100, wherein one or more of the pick-up zones 130, 132, and 134 include a stop and may include container sensor 165 integrated therewith.

FIG. 7 illustrates a mobile processing module 700 being used with a conveyor 799 and multiple stops 710, 720, 730, that are used to define multiple pick-up zones on the conveyor 799. The mobile processing module 700 also includes corresponding visual displays 740, 750, 760, for each of the multiple pick-up zones. A frame (not shown) of the mobile processing module 700 can support the stops 710, 720, 730, and the visual displays 740, 750, 760. Support arms may be used with the frame for positioning and supporting the stops 710, 720, 730. The stops 710, 720, 730, can operate from under rollers of the conveyor 799 as stop 620 in FIG. 6 or can be attached to the frame and operate from above the conveyor 799. The visual displays 740, 750, 760, can operate as the visual display 630 of FIG. 6.

The disclosure advantageously provides systems, methods, modules, and features that provide improvements for processing containers. The disclosure provides improvements for unloading and sorting (or aggregating and loading) more efficiently (as measured in man-hours) and that can be scalable to as many different processing layouts as possible. As such, the disclosure provides solutions for quick and easy adjustability and modularity.

Wherein the bottlenecks for processing containers can be attributed to the human operators, (not conveyance speed for instance), their rate of processing can be determined by the average distance travelled to and from the conveyance element per operator, per container to be handled (with transit speed of operator as a variable given) and the average amount of time spent by an operator at the conveyor mentally examining and processing containers to determine if that container should be processed by them. Additionally, the average amount time spent walking up and down the conveyor (to index containers downstream for example, or to take boxes back upstream to other operators who had missed that container) contributes to their rate of processing. The disclosure provides improvements that can alleviate the processing rate.

A portion of the above-described apparatus, systems or methods may be embodied in or performed by various devices, such as conventional, digital data processors or computers, wherein the computers are programmed or store executable programs of sequences of software instructions to perform one or more of the steps of the methods. The software instructions of such programs or code may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter. Configured or configured to means, for example, designed, constructed, or programmed, with the necessary logic, algorithms, processing instructions, and/or features for performing a task or tasks.

Those skilled in the art to which this application relates will appreciate that other and further additions, deletions, substitutions and modifications may be made to the described examples.

Each of the aspects disclosed in the Summary can have elements of one or more of the below dependent claims in combination.

What is claimed is:

1. A system for processing containers, comprising:
a conveyor that transports containers;
at least one ID sensor that obtains sensed data as the conveyor transports the containers;
one or more visual displays for providing visual data; and
one or more processors to perform operations including:
determining container data based at least on the sensed data, and
displaying the container data on the one or more visual displays.

2. The system as recited in claim 1, wherein the container data includes sorting instructions for the containers.

3. The system as recited in claim 1, wherein the conveyor transports the containers through one or more pick-up zones and each of the one or more pick-up zones include one of the one or more visual displays that displays the container data for one of the containers located within a corresponding one of the one or more pick-up zones.

4. The system as recited in claim 3, wherein the one of the containers is located within multiple of the one or more pick-up zones and the one of the one or more visual displays of each of the multiple pick-up zones displays the container data.

5. The system as recited in claim 1, wherein the one or more visual displays is a single display.

6. The system as recited in claim 5, wherein the single display is a scrolling display.

7. The system as recited in claim 1, wherein the sensed data identifies product within the containers.

8. The system as recited in claim 7, wherein the sensed data further indicates a condition of the product.

9. The system as recited in claim 1, wherein the conveyor transports the containers through different pick-up zones.

10. The system as recited in claim 9, wherein the conveyor receives the containers on one side of the at least one sensor and the different pick-up zones are positioned along the conveyor on the opposite side of the at least one sensor.

11. The system as recited in claim 10, wherein the conveyor automatically transports the containers.

12. The system as recited in claim 1, further comprising one or more container sensors that indicates a location of the containers on the conveyor and indicates when the containers have been removed from the conveyor.

13. The system as recited in claim 1, wherein the containers are from a delivery and the operations further include receiving delivery data of the containers of the delivery and determining the containers of the delivery that have been received based on the delivery data and the sensed data.

14. The system as recited in claim 13, further comprising a screen associated with the one or more processors that visually represents a sorting status of the containers.

15. The system as recited in claim 13, wherein the system is a sorting system for the containers at a customer site and the container data is based the sensed data, the delivery data, and customer data for the customer site.

16. A method of processing containers from a delivery, comprising:
receiving delivery data of the delivery;
receiving the containers of the delivery;
transporting the containers using a conveyor past at least one ID sensor;
sensing product data from the containers using the at least one ID sensor; and
visually presenting container data for the containers, wherein the container data is at least based on the product data.

17. The method as recited in claim 16, further comprising determining the products of the delivery that have been received by comparing the product data to the delivery data.

18. The method as recited in claim 16, wherein sensing the product data includes scanning one or more barcodes associated with the containers.

19. The method as recited in claim 16, further comprising receiving customer data and generating the container data based on the delivery data, the customer data, and the product data.

20. The method as recited in claim 16, further comprising reporting a sorting status using the sensed data and data from a container sensor.

21. The method as recited in claim 16, further comprising moving the containers to different pick-up zones of the conveyor.

22. The method as recited in claim 21, further comprising automatically moving the containers to different pick-up zones of the conveyor.

23. A controller for a product processing system, comprising:
one or more processors to perform operations including:
receiving product data from containers on a conveyor
receiving customer data associated with the product processing system; and
visually presenting container data in one or more pick-up zones associated with the conveyor, wherein the container data is based on at least one of the product data or the customer data.

24. The controller as recited in claim 23, further comprising generating the container data from based on at least one of the product data or the customer data.
